(19) United States
(12) Patent Application Publication
(10) Pub. No.: US 2013/0328488 A1
(43) Pub. Date: Dec. 12, 2013

(54) LED LIGHT STRING AND CONTROL METHOD THEREOF

(71) Applicant: Jerry CHEN, Guang Zhou City (CN)

(72) Inventor: Jerry CHEN, Guang Zhou City (CN)

(21) Appl. No.: 13/491,072

(22) Filed: Jun. 7, 2012

(51) Int. Cl. H05B 37/02

(52) U.S. Cl. 315/154

(57) ABSTRACT

A LED light string contains at least two LED light sets, an adjustable remote control, and a control host, each LED light set including at least one LED light series-connected, between the each LED light set and the control host being connected a transistor, wherein the adjustable remote control includes a button set, a subhost, and a TX transmitter module, the sub host includes a TX coding module f, and a variation of a pressed time and/or a pressing method of the control button generates a press signal received and coded by the TX coding module, a control signal is transmitted to the control host by the TX transmitter module to correspond to the press signal; the control host includes a RX receiver module and a host connected with the RX receiver module.

### BACKGROUND OF THE INVENTION

1. Field of the Invention

The present invention relates to a LED light, and more particularly to a LED light string and a control method thereof which is capable of controlling and shifting different light flashes by ways of a pressed time and a pressing method.

2. Description of the Prior Art

LED light has an energy saving advantage and an environmental protection advantage and is applied to indication lights, traffic lights, displays, car lights, and micro-flashlights to flash different lights.

Accordingly, developing LED light string to control and shift different light flashes is an important concern.

The present invention has arisen to mitigate and/or obviate the afore-described disadvantages.

### SUMMARY OF THE INVENTION

The primary object of the present invention is to provide a LED light string and a control method thereof which is capable of controlling and shifting different light flashes by ways of a pressed time and a pressing method.

A LED light string provided by the present invention contains:

at least two LED light sets, an adjustable remote control, and a control host, each LED light set including at least one LED light series-connected, between the each LED light set and the control host being connected a transistor, characterized in that:

the adjustable remote control includes a button set, a subhost, and a TX transmitter module, the sub host includes a TX coding module for saving predetermined transmitting codes, and a variation of a pressed time and/or a pressing method of the control button generates a press signal received and coded by the TX coding module, and then a control signal is transmitted to the control host by the TX transmitter module to correspond to the press signal;

the control host includes a RX receiver module and a host connected with the RX receiver module, the RX receiver module receives the control signal transmitted by the TX transmitter module and then transmits the control signal to the host, thereafter the host analyzes the control signal and transmits a flash changing signal to drive the transistor to control a light flash of the each LED set, such that the LED light string is capable of controlling and shifting different light flashes by ways of the pressed time and the pressing method.

A control method of the LED light string provided by the present invention contains:

S100 including receiving a button signal from a control button by using the TX coding module of the adjustable remote control, transmitting the control signal to the control host after the control signal is coed, wherein the TX coding module saves predetermined transmitting codes which correspond to different pressed times or a pressing method of the control button, and then the control signal is transmitted to the control host by the TX transmitter module after being coded;

S200 including controlling the RX receiver module to receive the control signal transmitted by the TX transmitter module and then transmitting the control signal to the host;

S300 including analyzing the control signal by ways of the host and transmitting the flash changing signal to drive the transistor to control the light flash of the each LED set.

### BRIEF DESCRIPTION OF THE DRAWINGS

FIG. 1 is a diagram of an adjustable remote control of a LED light string according to the present invention;

FIG. 2 is a diagram of a control host of a LED light string according to the present invention;

FIG. 3 is a flow chart showing the control steps of the LED light string according to the present invention;

FIG. 4 is a circuit diagram showing the operation of the LED light string according to the present invention;

FIG. 5 is a circuit diagram of the LED light sets of FIG. 4.

### DETAILED DESCRIPTION OF THE PREFERRED EMBODIMENTS

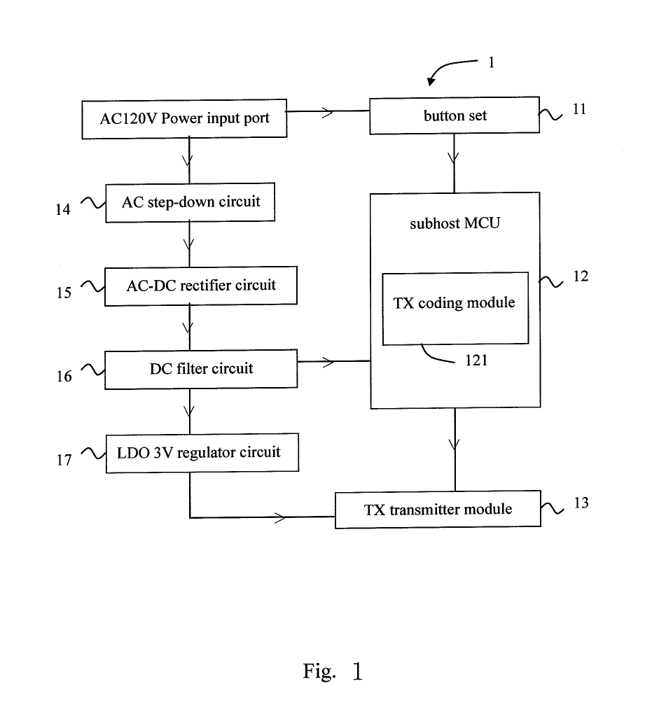

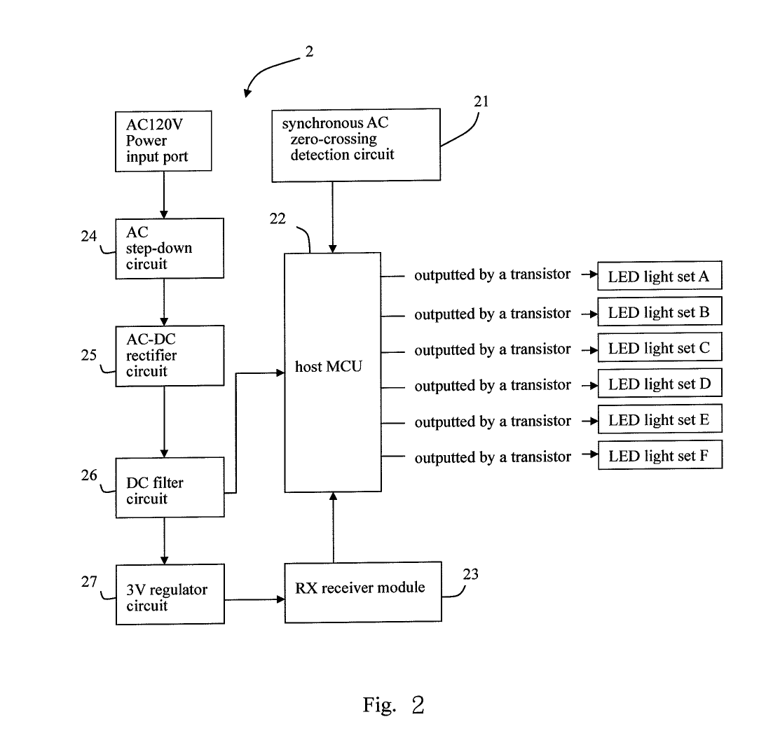

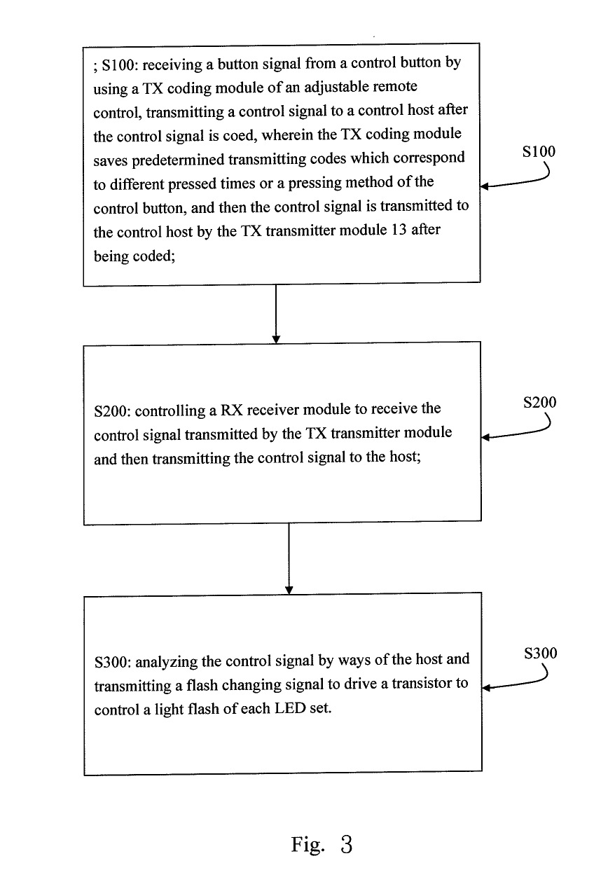

Referring to FIGS. 1 and 2, a LED light string according to the present invention comprises at least two LED light sets, an adjustable remote control 1, and a control host 2, wherein each LED light set includes at least one LED light series-connected, between the each LED light set and the control host 2 is connected a transistor, the adjustable remote control 1 includes a button set 11, a subhost MCU12, and a TX transmitter module 13, the button set 11 includes a control button and a switch (not shown), the control button controls the TX transmitter module to transmit a control signal based on a variation of a pressed time of the control button. The sub host 12 includes a TX coding module for saving predetermined transmitting codes, and a variation of the pressed time and/or a pressing method of the control button generates a press signal received and coded by the TX coding module 121, and then the control signal is transmitted to the control host 2 by the TX transmitter module 13 to correspond to the press signal.

The control host 2 includes a RX receiver module 23 and a host MCU22 connected with the RX receiver module 23, the RX receiver module 23 receives the control signal transmitted by the TX transmitter module 13 and then transmits the control signal to the host MCU22, thereafter the host MCU22 analyzes the control signal and transmits a flash changing signal to drive the transistor to control a light flash of the each LED set, such that the LED light string is capable of controlling and shifting different light flashes by ways of the pressed time and the pressing method.

The variation of the pressed time of the control button generates different button signals, and the control signal is outputted based on the different button signals to generate the flash changing signal, thus changing light flashes. The different pressed times, for instance, from one time to seven times, the light flashes are shifted and looped. Furthermore, when providing different numbers of buttons, each corresponding to a control of different light flashes, the different light flashes are controlled and shifted.

It is to be noted that the adjustable remote control 1 and the control host 2 are connected in a wired connection manner or a wireless connection manner.

Preferably, the adjustable remote control 1 transmits the control signal to the control host 2 in the wireless connection manner, thereby obtaining a flexible control. When the adjustable remote control 1 is connected in the wireless connection manner, a carrier frequency point is 433 M, and the transmitter module 13 contains a TX transmitting circuit (not shown) connected with a transmitting antenna (not shown).

To achieve a more stable performance of the LED light string of the present invention, the adjustable remote control 1 and/or the control host 2 include a step-down circuit, a rectifier circuit, a filter circuit, and a regulator circuit. Because such an arrangement is well-known in the related field, further remarks are omitted. Preferably, the step-down circuit includes two AC step-down circuits 14, 24, the rectifier circuit includes two AC-DC rectifier circuits 15, 25, the filter circuit includes two filter circuits 16, 26, and the regulator circuit includes two LDO 3V regulator circuits 17, 27. Preferably, the control host 2 includes a synchronous AC zero-crossing detection circuit 21 to detect a zero-crossing signal so as to control a clock synchronization, and after shifting different flash modes in 3 seconds, a synchronous process starts.

The LED light string includes the at least two LED light sets, and the each LED light set includes a plurality of LED lights series-connected on the basis of actual requirement.

In a first embodiment of the present invention, the LED light string includes six LED light sets A, B, C, D, E, F, and each LED light set has a predetermined coding, for example, the pressed time of the control button is set to seven, and the TX coding module includes the predetermined transmitting codes to correspond to seven pressed times of the control button, the TX transmitter module transmits the control signal to correspond to the seven pressed times of the control button. The host MCU receives the control signal and outputs the flash changing signal to drive the transistor to control six light flashes of the six LED light sets.

The six light flashes include:

a first mode: the pressed time is one, and the six LED light sets A, B, C, D, E, F are powered on;

a second mode: the pressed time is two, A→AB→BC→CD→DE→EF→F, and the LED light set A is powered on (Nms)→the LED light set A and the LED light set B are powered on (Nms)→the LED light set B and the LED light set C are powered on (Nms) and so on;

a third mode: the pressed time is three, A→AB→BC→CD→DE→EF→F, and then the LED light set A is powered on (Nms)→the LED light set A and the LED light set B are powered on (aNms)→the LED light set B and the LED light set C are powered on (aNms) and so on, wherein a >1;

a fourth mode: the pressed time is four, A→AB→BC→CD÷DE→EF→F, and then the LED light set A is powered on (abNms)→the LED light set A and the LED light set B are powered on (abNms)→the LED light set B and the LED light set C are powered on (abNms) and so on, wherein b >a;

a fifth mode: the pressed time is five, A→AB→BC→CD→DE→EF→F, and then the LED light set A is powered on (abcNms)→the LED light set A and the LED light set B are powered on (abcNms)→the LED light set B and the LED light set C are powered on (abcNms) and so on, wherein c>b>a;

a sixth mode: the pressed time is six, the six LED light sets are powered on according to the first mode to the fifth mode;

a seventh mode: the pressed time is seven, and a loop is the first mode.

In a second embodiment of the present invention, the LED light string includes six LED light sets A, B, C, D, E, F, and a pressed time of a control button is set to nine, and a TX coding module includes predetermined transmitting codes to correspond to nine pressed times of the control button, a TX transmitter module transmits a control signal to correspond to the nine pressed times of the control button. A host MCU transmits the control signal and transmits a flash changing signal to drive a transistor to control eight light flashes.

The eight light flashes include:

a first mode: the pressed time is one, and a loop is started based on a second mode to an eighth mode, i.e., 2→3→4→5→6→7→8→2;

a second mode: the pressed time is two, and the LED light set F to the LED light set A are powered on and then powered off, an interval cycle is Nms;

a third mode: the pressed time is three, and the LED light set A to the LED light set F are powered on and then powered off, the LED light set F to the LED light set A are powered on and then powered off, an interval cycle is aNms, wherein a>1;

a fourth mode: the pressed time is four, A→AB→BC→CD→DE→EF→F, and the LED light set A is powered on (Nms)→the LED light set A and the LED light set B are powered on (Nms)→the LED light set B and the LED light set C are powered on (Nms) and so on;

a fifth mode: the pressed time is five, after two adjacent LED light sets flash, and the LED light set A to the LED light set F are powered on and then powered off, the LED light set F to the LED light set A are powered on and then powered off, the interval cycle is Mms;

a sixth mode: the pressed time is six, the LED light set A to the LED light set F are powered on and then powered off, a light leaking cycle is Fms;

a seventh mode: the pressed time is seven, the LED light set A to the LED light set F are powered on to flash light and then powered off, a light leaking cycle is Fms, and the interval cycle is Fms;

an eight mode: the pressed time is eight, the LED light set A to the LED light set F are powered on;

a nine mode: the pressed time is nine, the loop is the first mode.

When receiving a power-off signal transmitted from the adjustable remote control 1, the control host 2 powers off and enters a standby mode.

A control method of the LED light string of the present invention comprises steps of

S100 including receiving a button signal from a control button by using a TX coding module of an adjustable remote control 1, transmitting a control signal to a control host after the control signal is coed, wherein the TX coding module saves predetermined transmitting codes which correspond to different pressed times or a pressing method of the control button, and then the control signal is transmitted to the control host by the TX transmitter module 13 after being coded;

S200 including controlling a RX receiver module to receive the control signal transmitted by the TX transmitter module and then transmitting the control signal to the host;

S300 including analyzing the control signal by ways of the host and transmitting a flash changing signal to drive a transistor to control a light flash of each LED set.

Thereby, in a third embodiment of the present invention, the LED light string is comprised of six LED light sets A, B, C, D, E, F, a pressed time of a control button is seven, and a TX coding module includes predetermined transmitting codes to correspond to seven pressed times of the control button, wherein as pressing the control button, the TX transmitter module transmits a control signal to correspond to the seven pressed times of the control button, and a host MCU receives the control signal and transmits a flash changing signal to drive a transistor to control six light flashes of the six LED light sets.

Furthermore, in a fourth embodiment of the present invention, the LED light string is comprised of six LED light sets A, B, C, D, E, F, a pressed time of a control button is nine, and a TX coding module includes predetermined transmitting codes to correspond to nine pressed times of the control button, wherein as pressing the control button, the TX transmitter module transmits a control signal to correspond to the nine pressed times of the control button, and a host MCU receives the control signal and transmits a flash changing signal to drive a transistor to control eight light flashes of the six LED light sets.

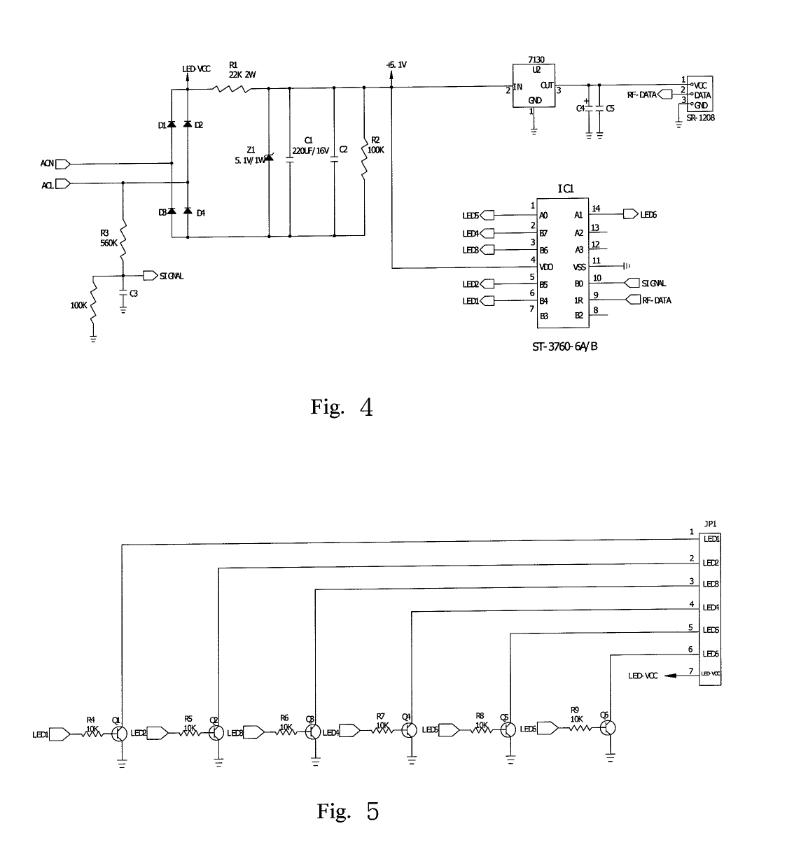

FIG. 4 and FIG. 5 are a circuit diagram showing the operation of the LED light string according to the present invention. D1, D2, D3, D4 are a rectifier diode to form a rectifier bridge pile, U2 is a chip regulator IC (HT7130 SOT-89), Z1 is a chip/pin zener diode (1N4733), IC1 is a chip main IC, Q1, Q2, Q3, Q4, Q5, and Q6 are a pin high-voltage transistor (A42/XV1225 one-way silicon), R1 is a pin carbon film/metal film resistors, C1/C4 are a pin electrolytic capacitor, JP1 is a pin terminal, SR-1208 is a receiver module. As shown in FIG. 5, each LED light set is series-connected.

While we have shown and described various embodiments in accordance with the present invention, it is clear to those skilled in the art that further embodiments may be made without departing from the scope of the present invention.

What is claimed is:

1. A LED light string comprising:
at least two LED light sets, an adjustable remote control, and a control host, each LED light set including at least one LED light series-connected, between the each LED light set and the control host being connected a transistor, characterized in that:
the adjustable remote control includes a button set, a subhost, and a TX transmitter module, the sub host includes a TX coding module for saving predetermined transmitting codes, and a variation of a pressed time and/or a pressing method of the control button generates a press signal received and coded by the TX coding module, and then a control signal is transmitted to the control host by the TX transmitter module to correspond to the press signal;
the control host includes a RX receiver module and a host connected with the RX receiver module, the RX receiver module receives the control signal transmitted by the TX transmitter module and then transmits the control signal to the host, thereafter the host analyzes the control signal and transmits a flash changing signal to drive the transistor to control a light flash of the each LED set, such that the LED light string is capable of controlling and shifting different light flashes by ways of the pressed time and the pressing method.

2. The LED light string as claimed in claim 1, wherein the adjustable remote control and the control host are connected in a wired connection manner or a wireless connection manner.

3. The LED light string as claimed in claim 1, wherein the LED light string is comprised of six LED light sets, the pressed time of the control button is seven, and the TX coding module includes predetermined transmitting codes to correspond to seven pressed times of the control button, wherein as pressing the control button, the TX transmitter module transmits a control signal to correspond to the seven pressed times of the control button, and the host receives the control signal and transmits a flash changing signal to drive the transistor to control six light flashes of the six LED light sets.

4. The LED light string as claimed in claim 1, wherein the LED light string is comprised of six LED light sets, the pressed time of the control button is nine, and the TX coding module includes predetermined transmitting codes to correspond to nine pressed times of the control button, as pressing the control button, the TX transmitter module transmits a control signal to correspond to the nine pressed times of the control button, and the host receives the control signal and transmits a flash changing signal to drive the transistor to control eight light flashes of the six LED light sets.

5. The LED light string as claimed in claim 1, wherein the button set includes a control button and a switch, the control button controls the TX transmitter module to transmit the control signal based on a variation of a pressed time of the control button.

6. The LED light string as claimed in claim 5, wherein the transmitter module contains a TX transmitting circuit connected with a transmitting antenna.

7. The LED light string as claimed in claim 1, wherein the adjustable remote control and the control host include a step-down circuit, a rectifier circuit, a filter circuit, and a regulator circuit.

8. A control method of the LED light string as claimed in claim 1 comprises steps of:
S100 including receiving a button signal from a control button by using the TX coding module of the adjustable remote control, transmitting the control signal to the control host after the control signal is coed, wherein the TX coding module saves predetermined transmitting codes which correspond to different pressed times or a pressing method of the control button, and then the control signal is transmitted to the control host by the TX transmitter module after being coded;
S200 including controlling the RX receiver module to receive the control signal transmitted by the TX transmitter module and then transmitting the control signal to the host;
S300 including analyzing the control signal by ways of the host and transmitting the flash changing signal to drive the transistor to control the light flash of the each LED set.

9. The LED light string as claimed in claim 8, wherein the LED light string is comprised of six LED light sets, the pressed time of the control button is seven, and the TX coding module includes predetermined transmitting codes to correspond to seven pressed times of the control button, wherein as pressing the control button, the TX transmitter module transmits a control signal to correspond to the seven pressed times of the control button, and the host receives the control signal and transmits a flash changing signal to drive the transistor to control six light flashes of the six LED light sets.

10. The LED light string as claimed in claim 8, wherein the LED light string is comprised of six LED light sets, the pressed time of the control button is nine, and the TX coding module includes predetermined transmitting codes to correspond to nine pressed times of the control button, as pressing the control button, the TX transmitter module transmits a control signal to correspond to the nine pressed times of the control button, and the host receives the control signal and transmits a flash changing signal to drive the transistor to control eight light flashes of the six LED light sets.
